(19) United States
(12) Patent Application Publication
(10) Pub. No.: US 2009/0300355 A1
(43) Pub. Date: Dec. 3, 2009

(54) Information Sharing Method and Apparatus

(76) Inventors: Stephen J. Crane, Bristol (GB); Daniel Gray, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/472,584

(22) Filed: May 27, 2009

(30) Foreign Application Priority Data
May 28, 2008 (GB) 0809589.5

(51) Int. Cl. H04L 9/32; G06F 15/16; H04L 9/08

(52) U.S. Cl. 713/168; 709/203; 726/7

(57) ABSTRACT

Embodiments of the present invention relate to methods and apparatus for sharing information with third parties and providing mechanisms whereby those third parties may legitimately pass the personal information on to other, for example affiliated, third parties. In one example of information sharing, information is shared electronically between an information provider and an information requester, the information provider storing a body of information and associated sharing criteria provided by an originator, receiving a first information request from a first requestor and revealing the information and the sharing criteria to the first requestor if the first request is authorised by the originator, receiving a second information request from a second requestor and revealing the information to the second requestor if the second request contains an information identifier obtained from the first requester and the sharing criteria so permits, and storing evidence of information requests.

People in general would like to restrict or control who has access to their personal identifying information, such as name, age, marital status, address, telephone number, national insurance number and the like. This is particularly true when individuals are required to share information with organisations who need to know the information in order to be able to fulfil obligations to the individual, e.g. to deliver a service. Individuals have to trust that the organisations will respect their privacy. However, there are regular reports in the press describing instances where personal information has been lost, misplaced or misused, and individuals end up with a distinct lack of faith—or trust—in organisations that request personal information. Part of this mistrust arises from reported privacy breaches, but it is also fuelled by a perceived lack of clarity and understanding about how personal information is used and by a fear that it will in any event be misused.

While the only way to guarantee that personal identifying information will not be lost, misplaced of misused is to not disclose it, this would be impractical in many if not most scenarios. However, systems and methods that enable individuals to maintain increased control over how their personal identifying information is used are desirable.

### BRIEF DESCRIPTION OF THE DRAWINGS

Embodiments of the invention will now be described, by way of non-limiting example, with reference to the accompanying diagrammatic drawings, in which:

FIG. 1 is a schematic diagram that shows an example of a three corner architecture including a user, an information provider and a relying party;

FIG. 2 is a schematic diagram that shows an example of a four corner architecture including a user, an information provider, a first relying party and second relying party;

FIG. 3 is a diagram that shows an example of a four corner architecture including a user, an information provider, a first relying party, second relying party and a cascade of additional relying parties;

FIG. 4 is a schematic diagram that illustrates how the additional relying parties can be modelled as second relying parties according to embodiments of the present invention;

FIG. 5 is a schematic diagram that illustrates an exemplary computer user interface presented by an on-line information provider for a user to enter their personal information and associated deletion and sharing preferences;

FIG. 6 is a flow diagram illustrating a protocol for passing user information from an information provider to a first relying party on the basis of user sharing preferences;

FIG. 7 is a flow diagram illustrating a protocol for revealing user information to a second relying party on the basis of a general proof token acquired automatically by a first relying party from a respective information provider; and

FIG. 8 is a flow diagram illustrating a protocol for revealing user information to a second relying party on the basis of a specific proof token acquired in response to a request by a first relying party from a respective information provider.

### DETAILED DESCRIPTION OF THE INVENTION

By way of background, two known models for identity sharing employ federated and centralised architectures. The approach referred to as federated identity management is characterised by the need to securely identify and authenticate individuals across multiple domains, and essentially embodies the concept of decentralised single sign-on. By contrast, centralised identity management is where individuals operate within the same ‘domain of control’, usually within the same organisation or network. This centralised approach is seen in wide use today, particularly with internal ‘corporate’ implementations and eCommerce solutions. However, individuals are generally not concerned whether the architecture they use is federated or centralised. They are simply concerned about the use of the personal information that they share with an organisation.

Although at least some of the examples that follow are based on a federated architecture, it will be appreciated that embodiments of aspects of the present invention may be applied to either federated or centralised architectures.

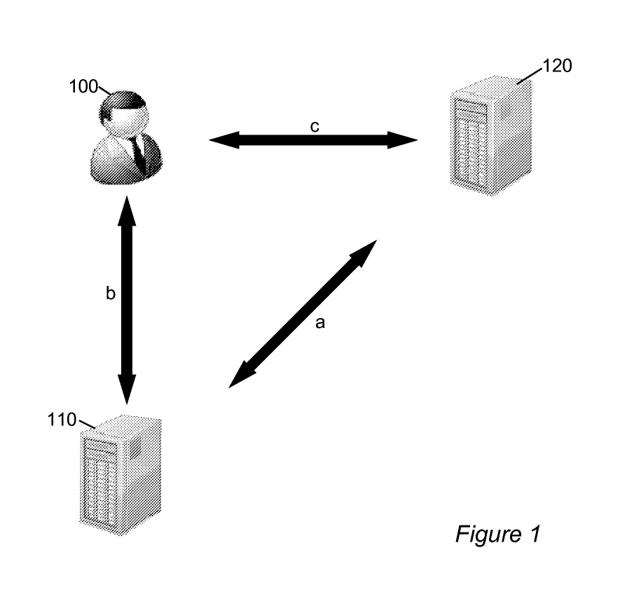

The diagram in FIG. 1 illustrates a federated architecture, in which a user 100 trusts third party information provider 110 with their information. A third party 120, which is, for example, an organisation that requires a user's information for some legitimate reason, is able to interact with the information provider 110, given the user's permission, in order to obtain the user's information. The premise of the architecture in FIG. 1 is that both the user 100 and the third party 120 trust the information provider 110. The user 100 trusts that the information provider 110 will not lose, misuse or misplace the information, and, moreover, will not disclose or reveal the information other than to parties authorised by the user. The third party 120 trusts the information provider 110 to ensure that the user's information is genuine. For this, it is expected that the information provider 110 would have authenticated the information it received from the user 100.

Although not shown in FIG. 1, the interactions between the user 100, the information provider 110 and relying party 120 would typically be by respective computers, for example operating under a HPUX™, Linux™ or Windows™ operating system, connected by standard arrangements of networks such as the Internet, or intranets, either directly or via access networks (which can be either by physical or wireless connection). Of course, individual communications across networks between entities would typically be protected by known security and privacy encryption protocols, for example SSL.

The diagram in FIG. 1 illustrates an example of a so-called ‘three-corner model’, due to the three players that are involved. The model is useful in the sense that the user 100 is fully aware of the information that is released by the information provider 110 to a third party 120, which will be referred to as a ‘relying party’, in the sense that the party is reliant upon the information for some reason. However, the model does not cater for situations in which the relying party 120 wishes to pass the information it received to another relying party (not shown), for example a partner organisation. If the relying party is entirely trustworthy, it may simply not pass information to other entities, assuming that is what the user wishes. If the relying party is not entirely trustworthy, it uses imperfect procedures to protect user information, or it relies on tacit user approval if they have not specifically disallowed information from being passed in this way, it is most likely that neither the user 100 nor the information provider 110 would know of any information transfer by the relying party 120 to another relying party (not shown).

While the diagram in FIG. 1 illustrates communications between the relying party 120 and the information provider 110 (via path a) in order to obtain the personal information, this may not be necessary. For example, the information provider 110 may at the request of the user pass information that is required by the relying party 120 back to the user 100 (via path b). The information may be passed back in verifiable form, for example signed by a private cryptographic key of the information provider 110. Then, the user 100 may pass the information to the relying party 120 (via path c), which can verify the validity of the information using a respective public key of the information provider in a known way.

It will be appreciated that direct communications between the information provider 110 and the relying party 120, via path a, or indirect communications between the information provider 110 and the relying party 120, via paths b and c, are alternative but equally valid options that would find application (unless otherwise stated or the context dictates otherwise) in the scenario in FIG. 1 and in the various scenarios that follow.

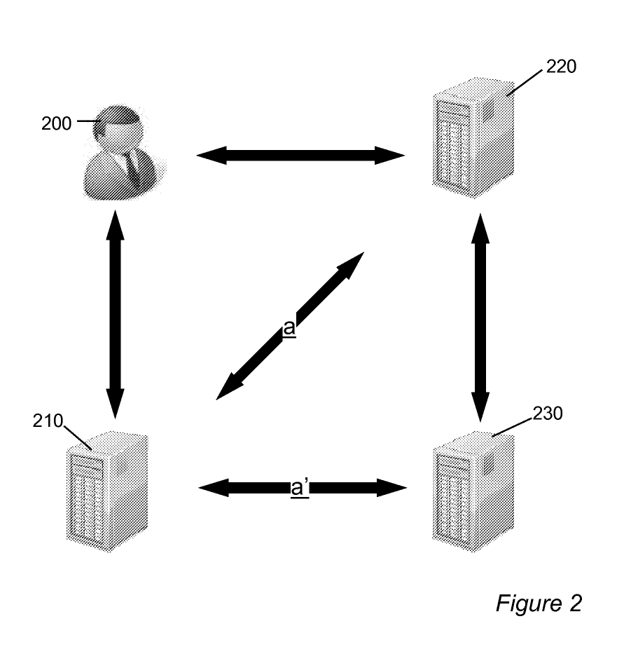

The diagram in FIG. 2 illustrates an architecture according to exemplary embodiments of the present invention, which can be referred to as a ‘four corner model’. The four corners are inhabited by a user 200, an information provider 210, a first relying party 220 and a second relying party 230. The model is conceived to accommodate situations in which the first relying party 220 wishes to pass information it received from the information provider 210 to the second relying party 230, in a way which keeps the user fully informed of such information passing.

As with the example in FIG. 1, the information may be provided to the first relying party 220 either directly by the information provider 210 or indirectly through the user 200.

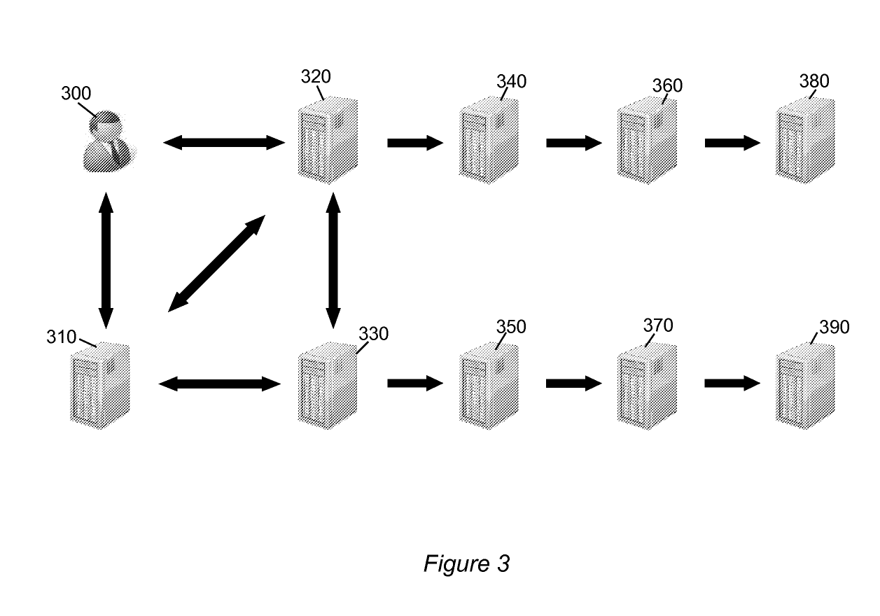

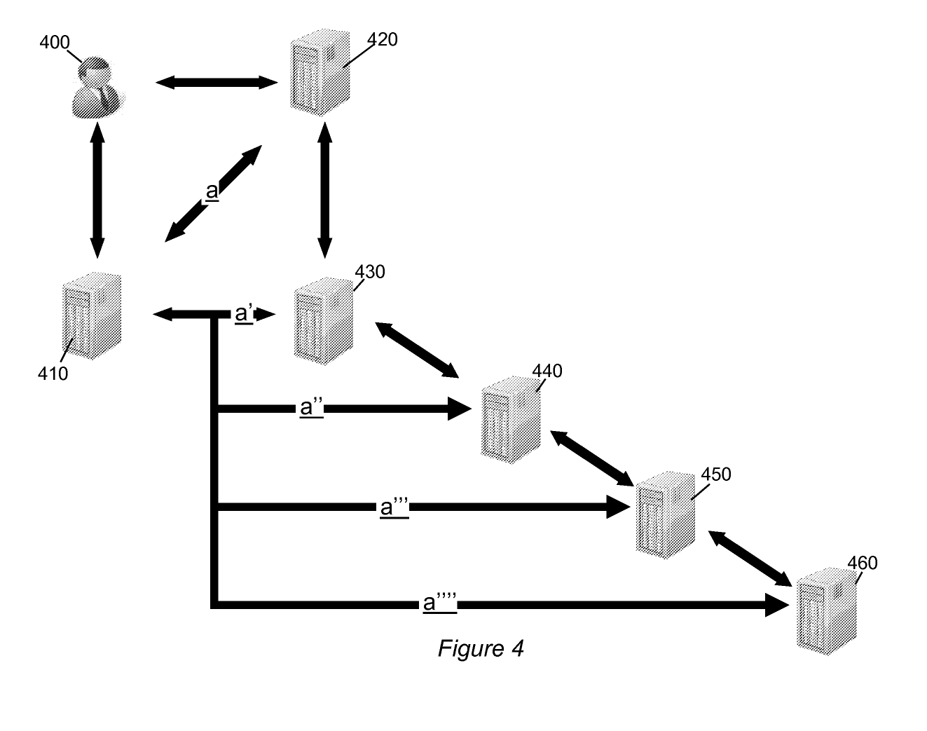

The four corner model can be extended as illustrated by the diagram in FIG. 3, in which there is user 300, an information provider 310, a first relying party 320, a second relying party 330 and a cascade of additional relying parties, each receiving information from a previous relying party. Although the cascade in FIG. 3 appears more complex than the simple four corner model in FIG. 2, for the present purposes, it is apparent that third 340, fourth 350, fifth 360 (and so on up to 390) relying parties are each equivalent in terms of status to the second relying party 330. This can be illustrated as shown in FIG. 4, wherein each subsequent relying party (440-460), which receives information, appears to be the equivalent of a second relying party 430, if the four corner model is applied.

The diagram in FIG. 4 includes a user 400, an information provider 410, a first relying party 420, and second 430 to fifth 460 subsequent relying parties. In essence, the third, fourth and fifth relying parties each appear to be the same distance, in terms of ‘hops’ between players, from the user as the second relying party 420. In FIG. 4, the players are shown to obtain information directly from the information provider 410, via paths a, a′, a″ etc, and so the number of hops is one (that is, from the information provider directly to the relying party). If the information goes via the user 400, which is not illustrated in FIG. 4, the information could be provided directly by the user to the respective relying party, and then the number of hops would be two (that is, from the information provider to the user and then to the respective relying party). Alternatively, if the user and information provider are treated as being the same logical entity (as they trust one another), then all relying parties can be thought of as being just one hop away from the user/information provider. In any event, according to the model in FIG. 4, each (subsequent) relying party can be thought of as a ‘first’ relying party. However, for ease of understanding only, relying parties will continue to be referred to as first, second, subsequent, etc.

Therefore, it is sufficient for the present purposes to consider only the simple four corner model of FIG. 2, although it is clear that what follows may be applied to any degree of cascaded relying parties.

As will be described, through an information provider, users can monitor and guide actions of organisations with which they share information, and, according to embodiments of the invention, can subsequently collect evidence of authorised and possibly unauthorised sharing (or attempted sharing). Such evidence enables the user to make informed choices about whether to trust an organisation in future. As described, according to embodiments of the invention, information may be thought of as being just ‘one hop away’ from the user irrespective of the number of shares by one relying party to another. The model provides a framework in which it appears the user has authorised information to be shared with each organisation directly, for example, as illustrated in the diagram in FIG. 4.

An embodiment of the present invention will now be described with reference to the four corner model illustrated in FIG. 2, in which the information provider 210 acts as an identity provider (IDP), which stores personal identifying information (P11). The PII is provided by users who trust the IDP 210 to look after their information. PII may include, for example, full name, age, marital status, sex, address, telephone number(s), national insurance number, social security number, health insurance number and the like. In addition to the PII, users provide sharing criteria, in the form of personal sharing preferences (PSP). The PSP inform recipients of the PII how, and indeed whether, the information can be shared by the recipients with other third parties. The preferences, of course, are adhered to by the IDP, as it is trustworthy, and should be adhered to by the recipients. As will be described, the preferences may include other criteria, such as ‘delete’ criteria.

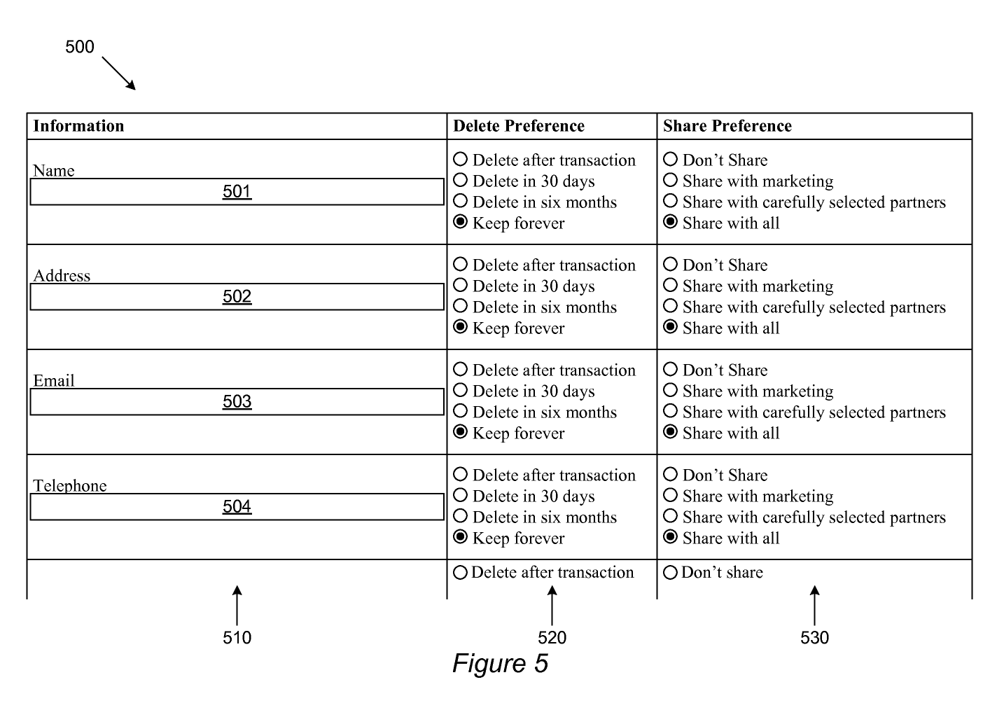

PSP are typically set by a user 200 via an on-line user interface 500, for example as illustrated in the diagram in FIG. 5. The user interface 500 may be provided as part of an on-line sign up software application, which is typically provided by the IDP 210. In FIG. 5, a user 200 is given an opportunity to identify various items of PII, for example, name 501, address 502, e-mail address 503, telephone 504, etc., in respective form fields in a left hand column 510 of the interface 500. Associated with each item of PII is a ‘Delete Preference’ in a middle column 520, and a ‘Share Preference’ in a right hand column 530 of the interface 500.

The Delete Preference for each item of PII include: ‘Delete After Transaction’, ‘Delete in 30 Days’, ‘Delete in 6 Months’ and ‘Keep Forever’. The Delete Preferences, in effect, provide the user with an opportunity to specify a shelf-life of the associated item of PII, after which time it is deemed out of date or no longer valid. The user would need to provide replacement data if any Delete Preference other than ‘Keep Forever’ is selected. In the example provided in FIG. 5, all data shown is likely to remain the same and, accordingly, ‘Keep Forever’ is appropriately shown selected.

The Share Preferences for each item of PII include: ‘Don't Share’, ‘Share With Marketing’, ‘Share With Carefully Selected Partners’ and ‘Don't Share’. The Share Preferences, in effect, provide the user with relatively granular control over whether the information can be shared and with whom it may be shared. Don't Share is self explanatory and it may apply to everyone except the user. This option may be used, for example, with a private encryption key belonging to the user. In effect, the IDP 210 becomes a secure repository for sensitive information. Share With Marketing indicates that the information can be shared with related companies of relying parties, for the purposes of gathering marketing information only. Relevant marketing information may be post (or zip) code information, indicating where users (who may be customers) live. It would not be appropriate to share this kind of information in a way which enables third parties to make contact with the user. Share with Carefully Selected Partners indicates that a relying party may share the information with others who may wish to contact the user, for example to sell goods or services that are in some way related to products or services brought by the user from the relying party. Share With All is self-explanatory.

The ‘Share’ and ‘Delete’ preferences are just two examples of the control that a user might want to impose on his PII. In practice, there could be many more types of preference, and some could be quite sophisticated, requiring other conditions external to the transaction to be met first. For example, a user might say, “Delete my data and never contact me again.” Of course, to achieve this, a relying party would have to keep at least an element of PII in order to record not to contact the user. As such, there would need to be logic that informs the user that the preference comprises mutually exclusive demands, one of which would need to be compromised on.

It will also be appreciated that PII can be defined in many other ways. For example, instead of having one set of PII in which each item has associated deletion and sharing preferences, there may be plural sets of PII for each user, with each set having single associated deletion and sharing preferences. In this way, a set having no sensitive information may have liberal PSP, for example permitting the information to be shared with anyone. Sets comprising additional, and/or more sensitive information would have more restrictive associated PSP.

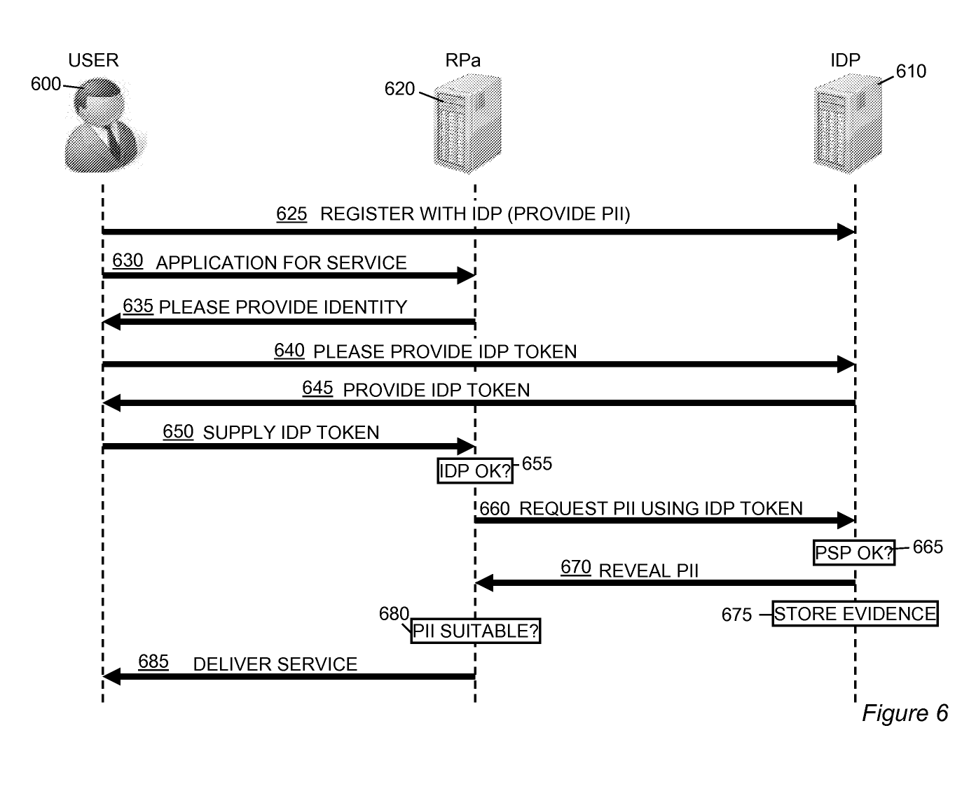

An exemplary process for revealing PII to a first relying party 220, will now be described with reference to the flow diagram in FIG. 6. The flow diagram includes three participants; a user 600, a first relying party (RPa) 620 and an IDP 610. In a first step [625], the user 600 signs up with the IDP 610. In this procedure, the user 600 provides the PII and the IDP 610 authenticates the information in a known secure way. In addition, the user 600 assigns PSP to the PII, so that the IDP 610 knows how to treat the information. Next [630], the user 600, for example, applies for an on-line service or initiates the process for buying a product. In response to the application, the relying party RPa 620 (for example, an on-line service provider or seller) requests PII from the user 600 [635]. The user 600, in turn [640], contacts the IDP 610 and requests a token. The token may be a reference to the PII or it may be the PII in encrypted form and it identifies the originating IDP 610. The IDP 610 authenticates the user 600 and provides the token [645]. In a next step [650], the user 601 delivers the token to the relying party RPa 620. The RPa 620 receives the token, identifies the IDP 610 and determines whether or not it can trust the IDP [655]. For example, the RPa may only trust a pre-determined set of selected identity providers. If the IDP is trusted by the RPa 620, then the RPa sends a request for the PII, including the token, to the IDP 610 [660]. The IDP 610 authenticates the token and checks the request against the associated PSP, to ensure that the requested PII can be revealed to the RPa 620 [665]. Assuming the token is verified and the request is allowed, the IDP 610, reveals the PII and the associated PSP to the RPa [670]. If the token is a reference, the act of revealing involves sending the PII to the RPa. If the token contains an encrypted version of the PII, the act of revealing may involve providing a key for the RPa 620 to decrypt the PII that it has already received from the user 600. Next [675], according to the present embodiment, the IDP 610 stores evidence of the request (irrespective of whether or not the request is completed by the IDP). Next [680], the RPa 620 determines whether or not the PII is suitable for the required purpose. Assuming it is, finally, the RPa 620 delivers the service or product to the user [685]. Service delivery may involve an actual delivery of some kind or it may simply permit the user to be authorised to access a web service or the like.

The flow diagram in FIG. 6 illustrates one way of delivering information and associated personal sharing preferences to a relying party in which the relying party obtains the information directly from the identity provider. As has already been mentioned, an alternative would be for the relying party to receive the information and personal sharing preferences from the identity provider via the user, the information having been verified by the identity provider.

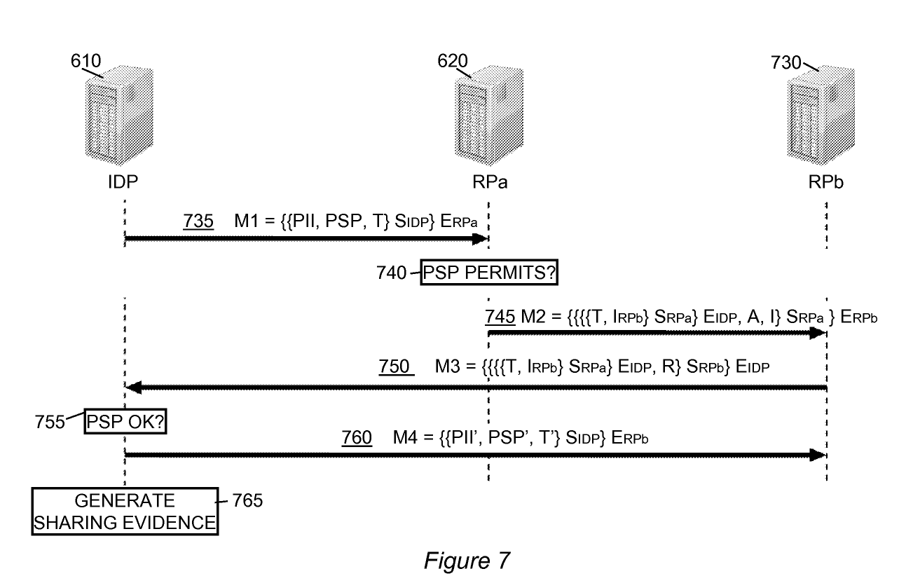

An exemplary process involving an IDP 610 for passing PII from a first relying party RPa 620 to a second relying party RPb 730 (which can be thought of as also being a first relying party according to embodiments of the present invention) will now be described with reference to the flow diagram in FIG. 7. It is assumed that the RPa has already obtained the PII and associated PSP, for example by the process of FIG. 6.

According to FIG. 7, in a first step [735], the IDP 610 generates a message M1 (or messages) to pass the PII and associated PSP to the RPa 620 along with a general proof token T. In the present example, T takes the general form {TokenRef, I_{RPn}}E_{IDP}, where TokenRef is a unique identifier (e.g. an alphanumeric string) generated by an IDP, I_{RPn} is the identity of an intended relying party n and { . . . } E_{IDP} indicates that the information within the braces is encrypted by IDP's private encryption key E_{IDP}. In this way, it can be seen that T binds an originating relying party, in the present instance RPa, to the TokenRef in a way that can only be revealed by the IDP 610. As will be described, the IDP will know that any request for PII it receives containing T is a legitimate request for information obtained via RPa. In other words, the general proof token is bound to RPa for all future uses of the token.

Returning to FIG. 7, the information {PII, PSP, T}, where T includes I_{RPa}, is signed by a signing key S_{IDP} of the IDP 610 so that the RPa 620 has an assurance that the information is genuinely from the IDP 610 and can be trusted. For security purposes, the signed information is also encrypted using a public encryption key S_{RPa} of RPa 620. Accordingly, only RPa, which has a respective private decryption key P_{RPa}, is able to decrypt the information. This step [735] is analogous to step 670 in FIG. 6, in which the PII is revealed to the RPa. However, in FIG. 7, T is also passed to the RPa, to enable the RPa to initiate the process of passing PII to the RPb 730, as will now be described.

In a next step [740], the RPa wishes to pass the PII to a third party, the RPb. However, the RPₐ is trustworthy and so it is arranged to evaluate the PSP to determine whether any PII can be shared and with whom. According to the present example it is assumed that PII can be shared with RPb.

Next [745], the RPa 620 generates a message M2 to pass to RPb. M2 includes T and an identifier I_{RPb} (identifying RPb) both signed by the signing key S_{RPa} of the RPa so that any recipient can establish that the information originated from RPa. This signed information is then encrypted using the public encryption key E_{IDP} of IDP 610. In effect, RPa augments T by binding it also to the identity of RPb. In other words, T is now bound both to RPa 620 and to RPb 730. The augmented proof token {{T, I_{RPb}} S_{RPa}} E_{IDP} is accompanied by an indication A, specifying which elements of the PII RPa is willing to reveal to RPb, and the identity I of the IDP (including, if necessary, information on how to connect to and communicate with the IDP). As a security measure, the entire message is then encrypted using the public encryption key E_{RPb} of RPb, so that only RPb can extract the information. With respect to A, in some instances, RPa may be willing to reveal all of the PII, in other instances, in particular if the PSP dictates that only a subset of the PII can be revealed, the set of information available to RPb may be restricted to fewer specified information fields: and A may or may not be necessary.

Next [750], the RPb 730 receives M2 from RPa 620 and undertakes to obtain the information from the IDP 610. RPb generates a request message M3 including the augmented proof token {{T, I_{RPb}} S_{RPa}} E_{IDP} and an indication R of which information it requires. R is most likely to be the same as, or a subset of, A, depending on RPb's requirements. The augmented proof token and R are signed using a signing key S_{RPb} of RPb and, for security, encrypted using the public encryption key E_{IDP} of IDP 610, so that only the IDP 610 can extract the information.

In a next step [750], on receipt of message M3, the IDP 610 extracts and identifies TokenRef and its binding with RPa 620. In addition, the IDP 610 identifies the new binding between T and RPb 730, which is a new player in the process as far as the IDP is concerned. However, the IDP 610 can see that the request is legitimate as it has originated from RPa 620, and RPa had clearly intended RPb 730 to be able to request the information, as RPa had bound RPb's identity to T, signed the augmented proof token and encrypted it as evidence for the IDP 610.

Next [755], the IDP 610 evaluates R and compares it with the PSP that are associated with the PII. Assuming R complies with the PSP, the IDP 610 generates a final message M4 to send to the RPb 730. M4 contains PII′ (or a subset thereof indicated by R), PSP′ (in case the RPb wishes to enable a subsequent relying party to obtain any PII) and a general proof token T′, all signed by IDP's signing key S_{IDP} and encrypted, for reasons of security, by RPb's public encryption key E_{RPb}. In this case, T′ is similar to T except it is bounds to RPb by the inclusion of I_{RPb} instead of I_{RPa}. As explained, PII′ may be the same as PII or it may be a subset of PII. Additionally, or alternatively, PII′ may contain updated information, which has changed or been refreshed since the original information was made available to RPa. Indeed, if the PSP has been modified (in which case it is PSP′), the PII′ may be restricted in some other way than was originally intended.

In essence, step 760 is analogous to step 735 and, if PSP′ permits, the RPb 730 may initiate another cycle of the process by passing a message comparable to M2 to another relying party.

Finally [765], the IDP 610 generates evidence that the information has been sent to RPb. In the event the PSP does not permit the PII to be sent to RPb, the IDP 610 still generates evidence of the request, which can be traced back to RPa. Subsequently, the user may review the evidence and decide that he no longer trusts RPa 620, which would influence how (or whether) he interacts with RPa in future.

It will be apparent that the process illustrated in FIG. 7 permits a first relying party to forward a general proof token directly to a second or subsequent relying party without recourse to a respective identity provider. In this case, the RPa is trusted to bind the proof token to the identity of the second or subsequent relying party.

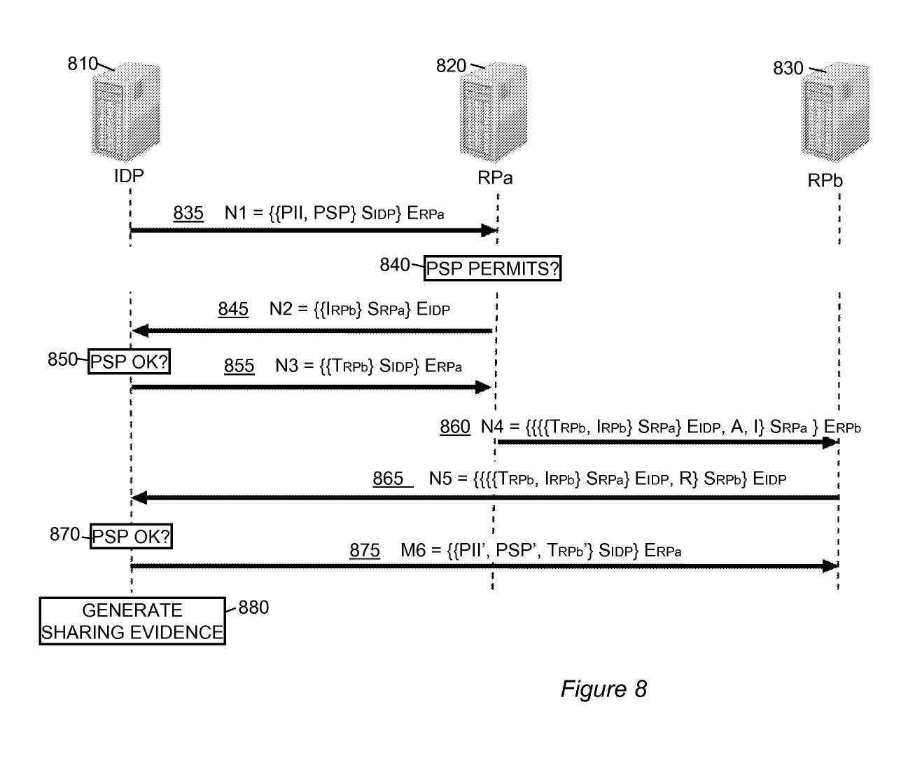

An alternative process for passing information to a second or subsequent relying party will now be described with reference to the flow diagram in FIG. 8.

According to FIG. 8, in a first step [835], the IDP 810 sends a first message N1 to the RPa 810. N1 is similar to M1 apart from N1 not including a proof token. Accordingly, while the RPa receives PII and associated PSP, it has no mechanism for enabling a second relying party, RPb 830, to obtain the information.

Consequently, according to the present example, the RPa 820 first checks that the PSP would permit information to be shared with the RPb [840]. If yes, the RPa 820 generates and sends a request message N2 to the IDP 810. N2 includes an identifier I_{RPb}, identifying RPb, which is signed by the RPa using its own signing key S_{RPa}, and encrypted using the public encryption key E_{IDP} of the IDP 810.

The IDP 810 receives the request message N2 and establishes [850] by reference to the PSP that the RPa 820 is allowed to enable the RPb 830 to obtain PII. In the answer is yes, the IDP 810 generates a response message N3. N3 includes a proof token T_{RPb} that is bound to the RPb 830. In the present example, T_{RPb} takes the general form {TokenRef, I_{RPb}} E_{IDP}, where TokenRef is a unique identifier as before generated by the IDP 810 and I_{RPb} is the identity of the intended relying party RPb 830. In this way, it can be seen that T_{RPb} binds a specified destination relying party, in the present instance RPb 830, to the TokenRef in a way that can only be revealed by the IDP 810. Finally, N3 is encrypted with the public encryption key E_{RPa}.

In a next step, the RPa 820 generates a message N5, which is equivalent to M2 in FIG. 7. Steps 860, 865, 870, 875 and 880 are analogous to the steps 745, 750, 755, 760 and 765, and will not be described again for reasons of brevity only.

An important distinction according to the process in FIG. 8, when compared to the process in FIG. 7, is that the IDP 810, and hence the user, know in advance that the RPb 830 has the potential to request the PII, even if RPb after receiving the proof token from RPa subsequently chooses not to submit a respective request.

According to embodiments of the invention, the first protocol illustrated in FIG. 7 can be adapted not to use proof tokens by, instead, arranging for the RPa 620 to pass the PII directly to the RPb 730 in step 745. In this case, the PII would typically be encrypted using a public key and passed by the RPa, in encrypted form, to the RPb 730, and the RPb would need to interact with the IDP 610 to obtain a respective decryption key, which can only be generated by the IDP. In either case, however, the PII is effectively revealed to the RPb, either by being unlocked (decrypted) after receipt or by being delivered in encrypted but decipherable form. This is an example where an Identifier Based Encryption (IBE) scheme could be employed to impose conditions that control RPb's access to the user's information. The conditions may be based on the user privacy preferences and may also include extra conditions that RPa wishes to impose, for example “access only permitted after a future date or time”. According to the IBE scheme, the conditions would represent a policy that is used as the encryption key, with the IDP subsequently generating and using (and providing) the corresponding decryption key or requested information. A disadvantage of such a protocol is that the RPa can send actual PII, albeit in encrypted form, directly to the RPb without any kind of notification to the IDP 610 or the user. The IDP 610 and user would only know the information transfer had occurred if the RPb subsequently submits a request for the decryption key. From a privacy perspective, it is typically preferable for all transactions to be recorded by the IDP 610. However, an advantage of the protocol is that the IDP only needs to send the PII once (to the RPa), with subsequent requests involving only transmission of decryption keys. Of course, if there are many potential RPb for a given RPa, the RPa may prefer to send only a proof token to each RPb in order to reduce the volume of information it needs to send. Also, if there is a risk that the PII may become out of date before it is accessed by the RPb, if may be preferable, again, to rely on use of proof tokens.

As described above, the examples illustrated herein are based on a federated architecture. In a particularly convenient embodiment, a known federated identity management system can be adapted for use according to the invention. Examples of federated identity management systems include OpenID <http://openid.net/>, Liberty Alliance <http://www.projectliberty.org/>, Higgins <http://www.eclipse.org/higgins/> and identity card schemes like Windows CardSpace <http://netfx3.com/content/WindowsCardspaceHome.aspx>.

For example, embodiments of the present invention can adapt and apply CardSpace. CardSpace already enables users to store PII with selected, trusted identity providers. These providers may in general be any person or organisation which users trust and relying parties are willing to trust. IDPs may be banks, stores, or bespoke identity providers. The CardSpace application operates with the Windows operating system and controls the provision of a user's PII to relying parties. Relying parties can request PII in the form of identity cards, containing personal information. For example, a relying party with whom the user is interacting on-line to buy a product may request a CardSpace card accredited by a certain bank or other financial institution. In response, the CardSpace application will identify if the user has such a card and then interact with the respective bank to obtain either the PII (signed by the bank) or a proof token, of the kind described above. As it stands, there is no mechanism in CardSpace to facilitate and track the passing of information by a first relying party to a second or subsequent relying party. In other words, CardSpace is based on a three corner model, in which there is no provision for user preferences, for example PSP, to be evaluated and acted on by an IDP. However, by adapting CardSpace cards to include such user preferences, and enforcing IDPs to check the preferences and generate evidence of requests from relying parties (first, second or subsequent), users can be provided with an improved and flexible system which facilitates the protocols and processes at least as exemplified in FIGS. 7 and 8.

In applying the CardSpace application to embodiments of the present invention, information fields in a user's PII are presented in the form of so-called CardSpace ‘Claims’. In this context, Claims are information fields that the IDP has accredited and claim to be true and accurate. With respect to FIGS. 7 and 8, references in the message protocol to PII would be replaced by those CardSpace Claims that are allowed, according to the PSP, to be passed to first, second and subsequent relying parties.

The above embodiments are to be understood as illustrative examples of the invention. Further embodiments of the invention are envisaged. For example, in all embodiments, PII, Claims or equivalent can be passed from a first relying party to a second relying party directly in encrypted form, and then revealed to the second relying party by it acquiring a respective decryption key from an IDP. Alternatively, as described in detail herein, PII, Claims or equivalent can be passed to a second relying party directly (in unencrypted form) by an IDP, in response to the second relying party presenting the IDP with a legitimate proof token. As described, the proof token may be a general one, which is bound to the identity of the first relying party and passed automatically to the first relying party, or it may be a specific one, provided in response to a request from the first relying party, which particularly identifies the second relying party. In addition, with regard to capturing and storing evidence of information requests (as illustrated in FIGS. 6, 7 and 8), this is clearly an important feature of embodiments of the present invention, which allows a user to establish whether a relying party is trustworthy, and which may influence how (or if) the user would trust a particular relying party in future. However, in other embodiments, it may not be a requirement that this kind of evidence is captured and stored, for example, if there is sufficient trust by the user of the information provider. In other embodiments, evidence may be collected selectively, for example, it may only be necessary to capture evidence of unauthorised requests or requests that, for whatever reason, cannot be completed, or requests that rely on tokens that are beyond an acceptable ‘use-by’ date, or only for requests that use a token from a second (or subsequent) relying party (or requestor), or the like. Obviously, many different criteria dictating whether or not to capture evidence of requests may be conceived on the basis of the disclosure herein. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of sharing information electronically between an information provider and an information requester, the information provider:
storing a body of information and associated sharing criteria provided by an originator;
receiving a first information request from a first requester and revealing the information and the sharing criteria to the first requester if the first request is authorised by the originator;
receiving a second information request from a second requester and revealing the information to the second requester if the second request contains an information identifier obtained from the first requestor and the sharing criteria so permits; and
storing evidence of information requests.

2. A method according to claim 1, wherein the first request includes a first token obtained by the first requester from the originator, the first token serving as authorisation from the originator to reveal the information.

3. A method according to claim 1, wherein the second request includes a second token obtained by the second requester from the first requestor.

4. A method according to claim 3, wherein the second token is obtained by the first requester from the information provider, if the sharing criteria so permits.

5. A method according to claim 4, wherein the second token is provided by the information provider when revealing the information and the sharing criteria to the first requester.

6. A method according to claim 5, wherein the second token is bound to the identity of the first requester, whereby the first requestor can be identified as having provided the token in subsequent uses of the token.

7. A method according to claim 4, wherein the second token is provided by the information provider in response to a subsequent request by the first requester in which the second requester is identified.

8. A method according to claim 7, wherein the second token is bound to the identity of the first requester, whereby the first requestor can be identified as having provided the token in subsequent uses of the token.

9. A method according to claim 7, wherein the token is bound to the identity of the second requester, whereby the second requester can be identified in subsequent uses of the token.

10. A method according to claim 1, wherein the information is revealed to the second requester by communicating the information to the second requester in response to a respective request therefor.

11. A method according to claim 1, wherein the information is revealed to the second requestor by communicating a key to the second requestor, the key unlocking information that has already been communicated to the second requester, in an encoded state, by the first requestor.

12. A method according to claim 1, wherein the first requestor informs the second requester of what information is available from the information provider.

13. A method according to claim 12, wherein the second information request includes an indication of the information that is required by the second requestor.

14. A method according to claim 1, wherein information transfer between the originator and any requester is brokered by a federated identity management system, for example Windows CardSpace.

15. Information provider apparatus adapted for use in a system for sharing information electronically between the information provider and an information requester, wherein the information provider apparatus comprises:
a store storing a body of information and associated sharing criteria provided by an originator;
an input for receiving a first information request from a first requestor and a second information request from a second requester; and
a processing unit arranged, where the first request is determined to be authorised by the originator, to reveal the information and the sharing criteria to the first requestor, and, where the second information request contains an information identifier obtained from the first requester and the sharing criteria so permits, to reveal the information to the second requestor; the processing unit being further arranged to store evidence of the information requests.

16. Apparatus according to claim 15, wherein the first request includes a first token obtained by the first requester from the originator, the processing unit being arranged to treat the first token as providing authorisation from the originator to reveal the information.

17. Apparatus according to claim 15, wherein the second request includes a second token obtained by the second requester from the first requestor.

18. Apparatus according to claim 17, wherein the processing unit is arranged to provide the second token to the first requestor only if the sharing criteria so permits.

19. Apparatus according to claim 18, wherein the processing unit is arranged to provide the second token to the first requestor when revealing the information and the sharing criteria to the first requestor.

20. Apparatus according to claim 19, wherein the processing unit is arranged to check that the second token is bound to the identity of the first requester, whereby the first requestor can be identified as having provided the second token.

21. Apparatus according to claim 18, wherein the processing unit is arranged to provide the second token to the first requester in response to a subsequent request by the first requestor in which the second requester is identified.

22. Apparatus according to claim 15, wherein the processing unit is arranged to provide the information to the second requestor by communicating the information to the second requester in response to a respective request therefor.

23. Apparatus according to claim 15, wherein the processing unit is arranged to provide the information to the second requestor by communicating a key to the second requester thereby to enable the second requestor to unlock an encoded version of the information communicated to it by the first requestor.
